(19) United States
(12) Patent Application Publication
(10) Pub. No.: US 2010/0290062 A1
(43) Pub. Date: Nov. 18, 2010

(54) Microstructured fibre bragg grating sensor

(76) Inventors: Minh Chau Phan Huy, Maisons Alfort (FR); Véronique Dewynter-Marty, Gif S/Yvette (FR); Guillaume Laffont, Bois D'Arcy (FR); Pierre Ferdinand, Houilles (FR); Wilfried Blanc, Nice (FR); Bernard Dussardier, Colomars (FR); Dominique Pagnoux, Limoges (FR); Philippe Roy, Limoges (FR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/308,297

(22) PCT Filed: Jun. 13, 2007
(86) PCT No.: PCT/EP2007/055823

§ 371 Date: Jul. 28, 2010

(30) Foreign Application Priority Data
Jun. 13, 2006 (FR) 06/05239

(51) Int. Cl. G01N 21/41; G02B 6/00

(52) U.S. Cl. 356/517; 385/12; 385/37

(57) ABSTRACT

The invention involves a sensor (100) with a Bragg network fiber including a source (105) and detection system (101), operating at a wavelength of a given study, in addition to a Bragg (6) network fiber (1) linked to said source and said system, with said fiber being a microstructured optic fiber whose sheath (5) includes channels (3) adjacent to the heart (2) of the fiber (1), capable of receiving a product to be analyzed, characterized in that the number of channels (3) adjacent to the heart (2) is between 2 and 5, and that the size of the heart (2) of the fiber (1) is adapted so that an electromagnetic field of a wave guided by the fiber is not confined in the heart (2) of the fiber (1), and the electromagnetic field extends into the channels (3).

### GENERAL FIELD

The invention relates to optic fibres and optic fibre sensors.

One of the classic applications of optic fibres relates in fact to the field of optic instrumentation and sensors.

In this field, significant needs are expressed for integrated systems, remote-searchable and highly sensitive to various parameters such as temperature, refraction index etc.

To respond to these needs, solutions consisting of linking optic fibres technology to that of Bragg gratings have been put forward, especially for improving the sensitivity of measuring optical parameters such as refraction index, or absorption coefficient of a given medium.

### PRIOR ART

### Fibre Optic Bragg Gratings Sensors (FBG)

Numerous solutions have already been proposed which integrate a Bragg network photo-inscribed in a conventional fibre.

An initial solution consists of linking a conventional optic fibre circular cross-section, the sheath of which has been attacked by hydrofluoric acid, with a straight-line Bragg grating inscribed in the core of this fibre.

The medium of which a parameter is to be measured encases the zone <<attacked>> by the acid.

The fibre obtained according to this initial solution exhibits major fragility since the diameter of the fibre is extremely reduced. This fragility proves particularly harmful to some uses of fibre, and consequently limits possible applications of such a fibre.

Such a fibre sensor is for example described in the document “High-resolution refractive index sensor by using thinned Fiber Bragg Grating,” Proceedings of the SPIE 5502, pp. 251-254 (2004) (A. Iadicicco, A. Cusano, A. Cutolo and M. Giordano).

A second solution is based on a profile of fibre section in D-shape. The sheath of the fibre can be attacked chemically, or even polished or attacked mechanically, whereas a straight-line Bragg grating is inscribed in the core of the former (K. Zhou, X. Chen, L. Zhang and I. Ben n ion, “Optical chemsensors based on etched fiber Bragg gratings in D-shape and multimode fibers”. OFS2005, pp. 158, 161. Proc. SPIE vol. 5855).

The D-shaped profile has better sensitivity to the refraction index of the medium surrounding the network than in the case of a straight-line Bragg grating inscribed in a conventional fibre.

However, chemical attack or machining makes the fibre fragile and consequently causes the above drawbacks.

Other solutions also propose registering a long-pitch or inclined-pitch Bragg grating in the core of a conventional fibre.

A conventional fibre in the core of which is inscribed a long-pitch Bragg grating is described by S. Khaliq, S. W. James and R. P. Tatam in “Enhanced-sensitivity fibre optic long-period grating temperature sensor,” Meas. Sci. Technol. 13, pp. 792-795 (2002).

G. Laffont and P. Ferdinand propose a conventional fibre in the core of which is inscribed an inclined-line Bragg grating (“Tilted short-period fiber-Bragg-grating-induced coupling to cladding modes for accurate refractometry,” Meas. Sci. Technol. 12 (7) pp. 765-70 (2001)).

To conduct analysis of a surrounding medium, this type of Bragg grating, the part of fibre where this network is located, must be fully immersed in the medium to be probed. This restriction substantially restrains the flexibility of using such a fibre.

Furthermore, obtaining and using the fibres proposed by these different techniques are often complex, thus further substantially limiting the extent of the fields of application in which such fibres can be utilised.

These different solutions first (D-shaped fibres) do not lead to a robust transducer (mechanically fragile fibre) and second (angled or long-pitch networks) allow only reduced multiplexing for a very small number of sensors on the same fibre.

Microstructured Fibre Sensors

Sensors combining fibres of microstructured type and Bragg gratings are already known, especially for offering extensive sensitivity to the refraction index of the medium to be analysed (M. C. Phan Huy, G. Laffont, V. Dewynter-Marty, P. Ferdinand, P. Roy, J-M. Blondy, D. Pagnoux, W. Blanc, and B. Dussardier, “Inscription of Bragg grating transducers in microstructured fibres for applications in refractometry”).

The microstructured fibres are generally made of silica, but can also be made of plastic. These fibres can be made for example of methyl polymethacrylate also designated as PMMA, polystyrene, fluorous polymer or CYTOP which is a transparent fluoro-resin of non-crystalline structure and whereof the designation is the object of trade mark protection. These fibres made of plastic can also be obtained by sol gel method.

These microstructured fibres comprise a certain number of longitudinal channels within the optic sheath, these channels optionally able to be filled with a solid, liquid or gaseous material, conveniently selected for transduction. These microstructured fibres also comprise a solid, liquid or gaseous core for guiding light by total reflection or by Prohibited Photonic Bands, according to configuration.

During their design these fibres flexibly define the optogeometric characteristics of the optic guide and its sheath and define fibres dedicated to specific optic functions (telecommunications, metrology . . . ).

However, classically developed microstructured fibres, for telecom needs for example, do not produce the considerable sensitivity preferred in applications such as measuring refraction, absorption, fluorescence indices, etc. The profile of these fibres does not in fact allow sufficient interaction between the mode of the guided optic wave spreading in the core and the product to be analysed.

### PRESENTATION OF THE INVENTION

An aim of the invention is to propose a Bragg grating sensor having improved sensitivity, for detection and measuring of any physical-chemical parameter having an influence on the effective index of the propagation mode of an electromagnetic wave, such as for example refraction index, density, concentration, luminescence, fluorescence, phosphorescence, time of fluorescence decrease etc.

Another aim of the invention is to propose a microstructured fiber Bragg grating sensor offering substantial flexibility of use and especially (though not limitatively) producing substantial sensitivity to the refraction index of the product to be analysed.

The invention relates especially to a fibre fiber Bragg grating sensor comprising a source and detection system operating at a wavelength of given study, as well as a fiber Bragg grating linked to said source and to said system, said fibre being a microstructured optic fibre whereof the sheath comprises channels adjacent to the core of the fibre, suitable for receiving a product to be analysed, characterised in that the number of channels adjacent to the core is between 2 and 5, and in that the diameter of the core of the fibre is adapted for an electromagnetic field of a wave guided by the fibre not to be confined in the core of the fibre, the electromagnetic field extending in the channels.

With such a sensor, interaction between the evanescent field of the guided wave and the product to be analysed is augmented. The sensitivity of the sensor is improved.

Such a sensor can further be defined by the following characteristics taken alone or in combination:
the diameter of the core is between 0.5 [symbol] and 20 [symbol]
the diameter of the core is between 3 [symbol] and 5 [symbol] for a wavelength of study of the order of 1.55 [symbol]
at least one Bragg network is inscribed in the core of the fibre,
the Bragg grating has a pitch of less than 10 [symbol]
the channels are separated from one another by radial bridges the thickness of which is between 0.01 [symbol] and 10 [symbol]
the fibre comprises exactly three channels adjacent to the core,
the fibre is made of silica or plastic, the plastic being especially produced from PMMA, polystyrene, fluorous polymer or CYTOP,
the core of the fibre is made of pure, or doped silica, or plastic material, the plastic being especially produced from PMMA, polystyrene, fluorous polymer or CYTOP,
the sensor also comprises a system for introduction and/or extraction of the product to be analysed in at least one of the channels.
the sensor is arranged to collect the waves reflected or transmitted by the Bragg network.

The invention also relates to a microstructured fibre Bragg grating comprised in a sensor according to the invention.

The invention further relates to a process for determining the structure of such a fibre according to which the diameter of the core of the fibre is determined by fixing a given level of confinement and a given core diameter, in that the sensitivity of the fibre comprising a core of the given diameter at the refraction index of a product to be analysed is determined by modelling, and in that this given diameter of the core is made to evolve iteratively as a function of the determined sensitivity.

Likewise, the invention proposes use of the sensor according to any one of the preceding characteristics for measuring a physical-chemical parameter having an influence on the effective index of the mode of propagation, such as for example refraction index, absorption coefficient, density, concentration, luminescence, fluorescence, phosphorescence, fluorescence decrease time.

### PRESENTATION OF THE DIAGRAMS

Other characteristics, aims and advantages of the present invention will emerge from the following detailed description, and with reference to the attached diagrams, given by way of non-limiting examples and in which:

FIG. 1a is a radial section of the fibre according to an embodiment.

FIG. 1b is an axial section of the fibre according to FIG. 1.

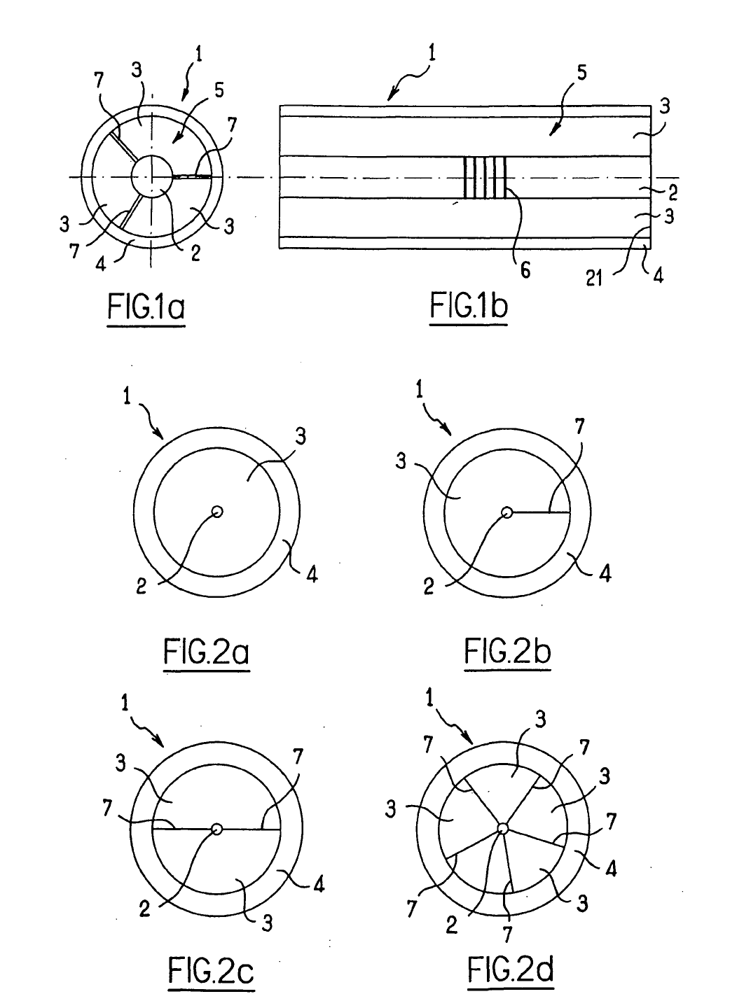

FIGS. 2a to 2d are radial sections of fibres according to other embodiments.

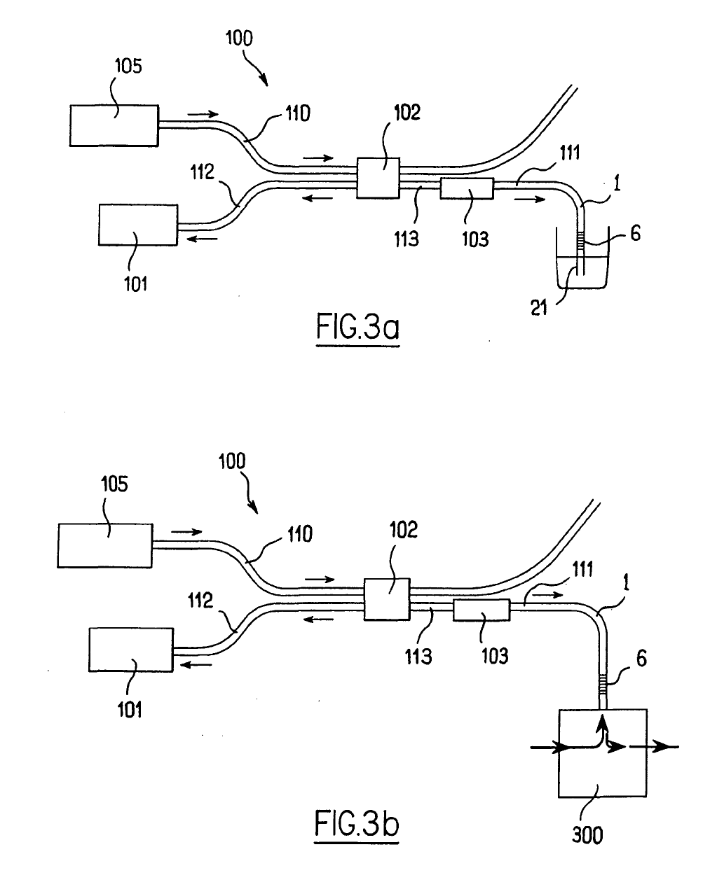

FIG. 3a is a sketch of a sensor according to an embodiment.

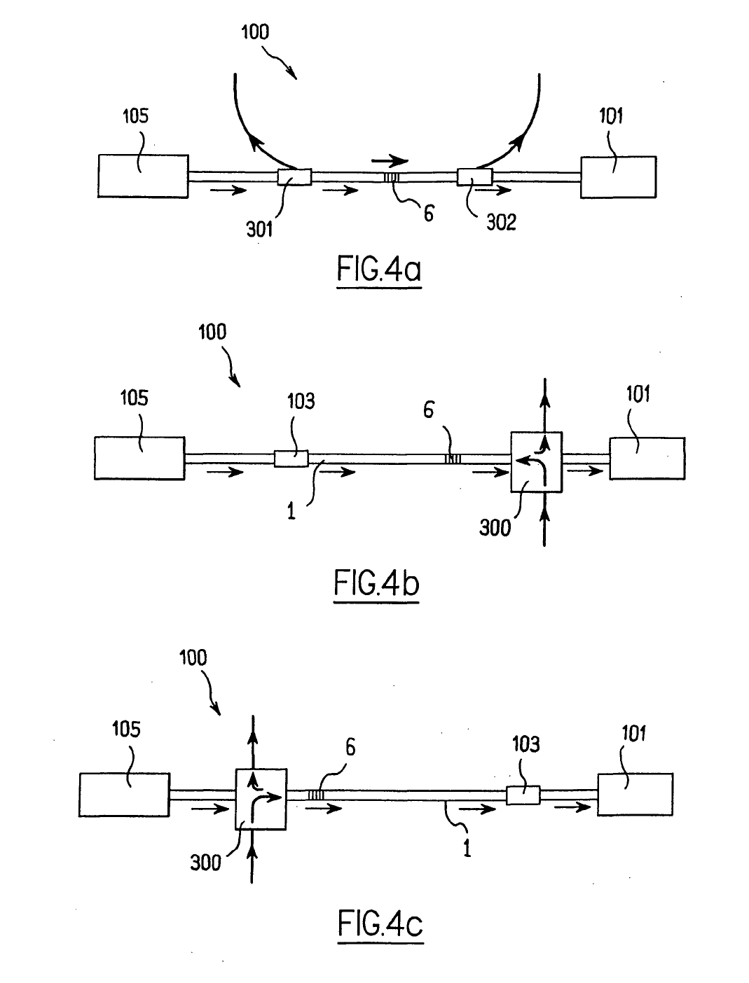

FIGS. 3b and 4a to 4c are sketches of sensors according to other embodiments.

### DESCRIPTION OF BRAGG NETWORK MICROSTRUCTURED FIBRES ACCORDING TO AN EMBODIMENT

### General Structure

In reference to FIGS. 1 and 1b, a fibre according to an exemplary embodiment is illustrated.

This fibre 1 is composed of a core 2, enclosed by a sheath 5.

The sheath 5 has a plurality of longitudinal parallel channels 3.

The presence of these channels 3 in the sheath 5 is characteristic of fibres called microstructured.

These channels 3 are adjacent to the core 2 and arranged so as to form a crown.

In addition, these channels 3 are separated from one another by very fine radial bridges 7 extending from the periphery 4 of the sheath 5 as far as the core 2. Accordingly, each channel 3 is delimited radially by the periphery 4 of the sheath 5 to the exterior, and by the core 2 to the interior.

Each channel 3 is also delimited tangentially by the radial bridges 7.

The core 2 can be made of pure silica, by omission of channel 3 in the central zone (central default) of the silica matrix. The core 2 can also be doped, with Germanium for example. This doping modifies the transmission characteristics in the core 2, at the same time giving the core a photosensitive character allowing photo-inscription of Bragg networks.

The sheath 5 and the radial bridges 7 are made of optionally doped silica, and the channels 3 are filled with air or a medium with refraction index less than that of the core (2).

In other embodiments the microstructured fibre could be made of plastic, and especially methyl polymethacrylate also designated as PMMA, polystyrene, fluorous polymer, or even CYTOP.

In the event where the wavelength of study is between 0.5 [symbol] and 2 [symbol] the diameter of the peripheral sheath 4 is for example between 50 [symbol] and 500 [symbol] and that of the core 2 between 1 [symbol] and 20

[symbol]

In the core 2 of the fibre 1 a Bragg network 6 is inscribed.

A Bragg network inscribed in the core of a fibre constitutes a network having several tens or even several thousands of periods or <<pitches>> modifying the refraction index of the core of the optic fibre. This type of network is understood as a filter for a spectral band centred on a so-called Bragg characteristic wavelength [symbol] This wavelength depends on the pitch □ of the network, and on the refraction index which <<sees>> the mode of propagation known as effective index n_{eff} of the guided mode.

Therefore for the straight-line Bragg network, the characteristic wavelength [symbol] is defined for example by the relationship

[symbol]

=2·n_{eff}·□ (1)

Thus, any modification of the effective index n_{eff} or of the pitch □ of the network causes proportional variation of the wavelength

[symbol]

Tracking this spectral displacement detects or measures the variation of the inductive physical parameter of this modification.

If the effective refraction index of the mode of the guided wave is influenced by a product surrounding the fibre, the precision of detection of the variation of the parameter to be measured from this product therefore depends especially on the sensitivity of the Bragg network to the refraction index of this product.

This Bragg network 6 is short pitch, the pitch being typically between 0.1 [symbol] and 10

[symbol]

According to a first example, the Bragg network 6 can be inscribed using a continuous laser (for example 244 nm), especially if the core is made of silica doped for example in Germanium. According to a second example, the Bragg network 6 can also be inscribed by means of a laser operating at a pulse rate (such as at 193 nm), if the core is for example made of pure silica or is plastic.

Behaviour During Functioning, Restrictions which Influence Performance, Advantages Gained by this Fibre.

In a first phase, the incident light spreads in the core 2 of the fibre 1 enclosed by channels 3.

In the case where the fibre guides the light by total reflections, the refraction index of the core 2 of the fibre is necessarily greater than that of air.

The effective index of the guided mode then has an initial value, between the value of the refraction index of the sheath 5 and the value of the refraction index of the core 2.

Since the wavelength characteristic of the Bragg network 6 is defined by the equation (1), this network extracts a fine spectral band centred around the characteristic wavelength

[symbol]

In a second phase a product to be analysed is introduced to at least one of the channels 3, for example in liquid or gaseous form.

This product introduction can be obtained by immersing an end of the fibre, or can be done by means of an injection device and withdrawal or extraction of the product inside the channels.

The refraction index of the product, greater than the refraction index of air, tends to substantially increase the average refraction index of the sheath 5.

The difference between the refraction indices of the sheath 5 and of the core 2 is therefore reduced. The light spreading in the fibre 1 is no longer exclusively guided by total reflection and the number of guided modes decreases. The refraction index of the guided mode, still between the refraction indices of the sheath 5 and of the core 2, increases.

When the liquid reaches the Bragg network 6, the variation of the refraction index of the guided mode in turn brings a variation of the wavelength characteristic of the network 6, in keeping with the equation (1). As the refraction index of the guided mode increases, the characteristic Bragg wavelength shifts towards the big wavelengths.

Therefore, the amplitude of the spectral offset is linked to variation of the refraction index of the guided mode and therefore to the refraction index of the inserted product.

Tracking the refraction index of the introduced product, in fine, detects or measures any physical-chemical parameter having an influence on the effective index of the mode of propagation, such as for example refraction index, concentration, density etc.

The fibre according to the embodiment considerably improves sensitivity of detecting this physical-chemical parameter by offering a particularly optimised fibre profile.

This improved sensitivity is obtained due to a fibre profile increasing the interaction between the product inserted in the channels 3 and the guided mode.

The penetration of the electromagnetic field in the sheath 5 and the channels 3 depends greatly on the wavelength. With short wavelengths, light remains confined in the core 2 of the fibre 1 and penetrates only slightly into the channels 3 of the fibre, while with larger wavelengths light extends more deeply into the channels 3.

The diameter of the core 2 must therefore be reduced to a maximum, and the product present in the channels 3 must be brought close to the maximum of the core 2 so as to increase the covering between the evanescent field and the medium to be analysed.

Dimensions and Arrangements of the Channels.

The profile is thus determined to produce large-size channels 3 which are brought as closely as possible to the core 2. The covering between the evanescent field and the product to be analysed is extended, and interaction between the fundamental mode and the product inserted is increased.

Enlarging the size of the channels 3 easily introduces the product to be analysed and produces a sheath 5 whereof the average refraction index is strongly influenced by the refraction index of the product filling the channels 3. To ensure the greatest interaction possible between the electromagnetic field of the guided wave and the medium to be analysed, the ideal case would be to have a microstructured fibre constituted by an air ring surrounding the core 2. Such a fibre 1 is illustrated in FIG. 2a.

The presence of radial bridges 7 however proves indispensable to the physical conduct of the fibre 1. The fibre 1 according to this embodiment therefore has an area ratio of silica constituting the sheath 5 on the area of the channels 3 which is as small as possible, the thickness of the radial bridges 7 being reduced to a minimum technically realisable to ensure only one physical holding function of the core 2.

According to a radial section of the fibre the thickness of the bridges 7 of silica is typically between 0.01 [symbol] and 10

[symbol]

The presence of channels 3 also brings the product to the Bragg network 6, and does not require dipping the network 6 in the product to be analysed. This particular feature offers numerous advantages in terms of simplicity and flexibility of use.

Diameter of the Core.

The diameter of the core must also be reduced to a maximum so as to increase the covering between the evanescent field and the medium to be analysed and such that the fibre is monomode or slightly multimode.

However, the determination of the diameter of the core 2 results from a compromise between confinement of the electromagnetic field and intensity of the optic signal.

In fact, reduction of the diameter of the core 2 is limited as it causes loss of the optic signal. A sufficient dimension of the diameter of the core 2 for ensuring guiding of light should thus be maintained.

The consequence of an excessively reduced core 2 also renders inscription of the Bragg network 6 complex.

Selecting a fibre profile 1, the diameter of the core 2 of which is of the order of the wavelength of study produces an electromagnetic field which does not remain confined in the core 2, but which instead extends into the channels 3, without as such causing the disadvantages associated with a too small core diameter.

In terms of the present application a diameter of the core 2 is considered as being of the order of the wavelength of study when it best respects the compromise between the guiding quality and the confinement of the electromagnetic field.

In practice, the diameter of the core 2 is determined by fixing a preferred level of confinement, then by deploying modelling software, typically by finished elements, with a given core diameter. As a function of the results obtained by modelling relating to sensitivity of the resonance wavelength of the Bragg network 6 to the refraction index of the product, the diameter of the core 2 of the fibre 1 is evolved.

An iterative approach is therefore employed, from a given fibre geometry adapted as a function of the results of successive modellings.

In general, the profile of the fibre 1 has a core whereof the diameter is just as small as the wavelength of study is short.

The fibre 1 whereof the profile is thus optimised as a function of the wavelength of study ensures strong interaction between the evanescent field and the product to be analysed, and consequently has considerable sensitivity of the resonance wavelength of the Bragg network 6 to the refraction index of this product.

Also, this heightened sensitivity is obtained over a wide range of refraction indices, and even for liquids with refraction index close to that of water.

The dimensions of such a fibre 1 are indicated, by way of non-limiting example, in this description hereinbelow.

Other Parameters

The profile of the fibre 1 must be adapted to the studied wavelength as pointed out earlier. In addition, the application made of the fibre 1 must also be taken into account in conceiving the profile of this fibre. The restrictions imposed by particular uses of the fibre 1 vary from one application to another, and consequently influence the conception of the profile of this fibre. For example, the number and thickness of the radial bridges 7 can be adapted as a function of the mechanical restrictions imposed by a particular use of the fibre 1.

The presence of radial bridges 7 in addition to the peripheral sheath 5 enclosing the core 2 ensures proper maintenance of the whole structure of the fibre, thus offering the latter a high degree of robustness and numerous possibilities for use.

Because the sensitivity of detecting the fibre proposed is independent of the total diameter of the fibre, the latter can be augmented to improve the mechanical characteristics of the fibre. This augmentation of the total diameter of the fibre, done by retaining a profile conforming with the above idea does not diminish the sensitivity of detecting the refraction index of the product.

To adapt to restrictions of use the optical geometric characteristics of the fibre, such as the number of radial bridges 7, the thickness of these bridges 7, the dimension of the bridges 7, the iterative method mentioned previously is undertaken regarding the determination of the diameter of the core 2 of the fibre 1.

This same iterative method also takes into account the forming restrictions in the conception of the profile of the fibre.

Therefore, numerous fibre profiles can be envisaged by respecting the previous idea. Some of these profiles are illustrated in FIGS. 2a to 2d.

FIG. 2a shows a fibre comprising a core enclosed by a ring of air or a material having an index less than that of the core 2.

The fibre illustrated in FIG. 2b comprises a single radial bridge, the fibre of FIG. 2c has 2 radial bridges placed on the same diameter, and the fibre of FIG. 2d comprises 5 radial bridges.

The fibre 1 according to one of the embodiments mentioned, associated with a device for analysis of the signal originating from the Bragg network 6, therefore quantifies or offsets the variation in any physical-chemical parameter having an influence on the effective index of the mode of propagation, such as for example refraction index, density, concentration, luminescence, fluorescence, phosphorescence, fluorescence decrease time etc.

The fields of application of such a fibre 1 are therefore particularly varied and include especially analysis of products in food processing, microbiology, environment, biology, biochemistry, aqueous solution measurements, novel techniques of biological analysis, immunoanalysis, etc.

Example of a Bragg Network Fibre Profile.

By way of non-limiting example an embodiment will now be explained in reference to FIGS. 1 and 1b.

According to this embodiment the fibre 1 comprises a core 2 doped with Germanium.

The fibre 1 comprises three channels 3 enclosing the core 2. The channels 3 are adjacent to the core 2. These channels 3 are separated from one another by very fine radial bridges 7 extending from the periphery 4 of the silica sheath 5 to the core 2 doped with Germanium. Each channel 3 is thus delimited radially by the periphery 4 of the sheath 5 and by the core 2, as well as tangentially by the radial bridges 7.

The channels exhibit a substantially identical cross-section according to a radial cut of the fibre.

The profile of this fibre 1 respects the principles of conception of profiles mentioned earlier to increase interaction between the electromagnetic field and the medium inserted into the channels 3.

In particular, the profile of the fibre 1 is defined such that the diameter of the core 2 is of the order of the wavelength of study. For a wavelength of study of the order of 1.55 [symbol] the diameter of the core is thus between 3 [symbol] and 5 [symbol] For the sake of clarity the proportions of the core 2 illustrated in the sketch in FIGS. 1a and 1b do not voluntarily respect the real proportions.

The area of each of the channels 3 is of the order of 1500 [symbol] ².

The thickness of the silica bridges 7 is defined such that the ratio of the area of silica comprising the sheath 5 to the area of the channels 3 is reduced to a maximum, ensuring physical retention of the fibre. The thickness of these bridges 7 can thus be between 0.01 [symbol] and 10

[symbol]

The exo-diffusion of hydrogen is reduced according to the method proposed by Beugin et al. [V. Beugin, V. Pureur, L. Provino, L. Bigot, G. Mélin, A. Fleureau, S. Lempereur, and L. Gasca, “Intérét Du Dopage Phosphore Pour la Photoinscription de Réseaux de Bragg Dans Une Fibre MicroStructurée,” Conference proceedings, 24th National Guided Optic Day (Chambéry), pp. 292-294 (2005)].

The fibre 1 is then introduced into the hydrogenation tube and is sufficiently hydrogenated, for example for two weeks at 180 bar and at 25° C.

In the core 2 of the fibre 1 a Bragg network 6 is photo-inscribed, for example at short pitch, whereof the pitch is of the order of 0.5 [symbol] for a working wavelength of 1.5 [symbol] Photo-inscription of the Bragg network 6 is done by continuous laser (for example at 244 nm).

The Bragg network 6 is inscribed by means of an inscription bank utilised for inscription of networks in conventional fibres: either a Lloyd mirror bank or a phase mask bank, or any optical system for creating the required interferences figure. The networks 6 inscribed in this microstructured fibre 1 typically exhibit reflectivity of the order of 70%, but can also attain any reflection coefficient selected during photo-inscription.

The profile of the fibre induces birefringence which raises the degeneration of the modes. Dedoubling of the Bragg peak associated with the fundamental mode corresponding to the polarisation states of the light appears. Adding a polarisation controller between the source and the microstructured fibre benefits one of the polarisations and therefore one of the resonance rays. By modifying the polarisation state of the source light, being placed in the case where one of the polarisations is favoured, only one of the resonances is observed on the spectral response in transmission and reflection of the Bragg network. The polarisation controller thus placed tracks the evolution of this resonance as a function of the refraction index of the product inserted in the channels of the fibre.

This device tracks the evolution of this resonance as a function of the refraction index of the medium inserted in the channels 3 of the fibre.

The Bragg network 6 is arranged in the fibre 1 so as to leave around only 1 cm of microstructured fibre between this network 6 and the downstream end 21 of this fibre 1 (the downstream end 21 being determined in reference to the direction of propagation of incident light). For example, splitting the end of the fibre renders all channels blind, thus introducing a liquid via capillarity into each of these channels simultaneously. Splitting consists of creating a small incipient fracture at the periphery of the fibre, then curving it until it breaks, which happens at the site of the primer, producing a clean cut perpendicular to the axis of the fibre.

Also, the fact that the Bragg network is located near the end reduces the fibre length to be filled before reaching the network. Association of a microstructured fibre to a Bragg network 6 with a short pitch collects light reflected by the Bragg network 6. The downstream end 21 of the fibre 1 is thus dipped into a product whereof a physical parameter is studied.

The fibre 1 described in this embodiment has considerable transduction sensitivity during measurement, and thus produces particularly satisfactory results.

In fact, spectral displacement of the Bragg resonance is several nm when a liquid of refraction index of the order of 1.3 (refraction index close to that of water) is inserted into the three channels 3 of the fibre 1. In comparison, when a similar liquid is inserted, the spectral displacement is merely 0.1 nm for a fibre having six channels and which has not been optimised according to the abovementioned principles (M. C. Phan Huy et al., “Fibre Bragg Grating photowriting in microstructured optical fibres for refractive index measurement”, Meas. Sci. Technol. 17, pp. 992-997 (2006).

The sensitivity of this fibre 1 thus illustrates improvement of more than an order of magnitude and more than two orders of magnitude relative to the sensitivity obtained with a fibre with 18 holes and a fibre with 6 holes respectively.

In fact, the sensitivity obtained with a fibre 1 having a profile according to this example is of the order of 10⁻⁵ u.i.r./pm (refraction index unit prt picombe), whereas this sensitivity is of the order of 10⁻⁴ u.i.r./pm and 10⁻³ u.i.r./pm for a fibre with 18 holes and a fibre with 6 holes respectively.

The profile of the fibre 1, realised according to this exemplary embodiment therefore allows remarkable sensitivity of the resonance wavelength of the Bragg network 6 to the value of the refraction index of the product present in the channels 3 of the fibre.

Exemplary Embodiments of Microstructured Fibre and Bragg Network Sensors.

FIGS. 3a and 3b illustrate a sensor 100 comprising a fibre 1 of the type of those described earlier.

The sensor 100 can be declined according to several embodiments. These different embodiments can be classed in two categories, according to which the Bragg network 6 inscribed in the core 2 of the fibre 1 operates in reflection or in transmission.

The sensors 100 operating in reflection comprise a light source 105, a detection system 101, a coupler 102, conventional fibres forming attachment arms 110, 112, 113, a microstructured fibre 1 with Bragg network, an alignment system 103 of an end 111 of the attachment arm 113 to the microstructured fibre 1. Two examples of these sensors 100 are illustrated in FIGS. 3a and 3b.

In reference to FIG. 3a, the source 105 emits a light arriving at a coupler 102 via a first arm 110. Half of the beam is guided to the microstructured Bragg network fibre by a second arm 113 of the coupler.

A third arm 112 of the coupler 102 is connected to the detection system 101 which acquires the data and in real time tracks the spectral offset of the Bragg wavelength of the guided mode with progression of the liquid in the channels 3 of the fibre.

The microstructured fibre 1 is linked to the end 111 of the attachment arm 113 of the optic fibre coming from the coupler 102 by a system 103 for aligning these two fibres and optimising the level of the output signal. Another possibility is to weld these two fibres together.

The free end of the microstructured fibre 1 dipped into the product to be analysed.

The Bragg network 6 inscribed in the core 2 of the fibre 1 has a short pitch. The advantage of this particular type of Bragg network 6 is to offer the possibility of operating in reflection. The network 6 can thus be placed at the fibre end. This placement of the network 6 offers considerable advantages translating especially by extensive flexibility of use.

Accordingly, such a sensor 100 has a simple configuration, which is particularly advantageous for some applications.

Another advantage is also the possibility of multiplexing several sensors with a number of ad hoc networks, more densely than with inclined-line networks. In fact, straight-line networks have a spectrum width (0.2 nm typically) around one hundred times less than the spectrum width of inclined-line networks. Therefore, over a given width of analysis spectrum it is possible to multiplex a number of straight-line networks greater than the number of inclined-line networks.

The sensor 100 illustrated in FIG. 3b operates according to the same general principle as the sensor 100 of FIG. 3a. In addition, this sensor 100 comprises, at the end of the microstructured fibre 1, a system 300 for insertion and extraction in the channels 3 of the product to be analysed.

The sensors 100 of the second category operate in transmission.

In the sensor 100 illustrated in FIG. 4a, the source 105 is linked to an end of a fibre 1 according to one of the embodiments indicated previously. The other end of this fibre 1 is linked to the detection system 101.

Means 301, 302 enable circulation of the product to be analysed in the channels 3 of the fibre. Circulation of the product to be analysed in the channels 3 can be done in both directions.

In the sensors 100 illustrated in FIGS. 4b and 4c, the optic source 105 is directly linked to an end of the fibre 1. At the other end of the fibre 1 a system 300 is integrated, for insertion and/or extraction of the product by the end of one or more channels (3) of fibre 1, and recovering and analysing the optic output signal of the core (2) of the fibre 1.

Advantages

As will be understood, the Bragg network microstructured fibres which have just been described have an optimised fibre profile enabling substantial improvement of measuring the refraction index of the medium to be analysed. The optimised profile of these fibres boosts interaction between the guided mode and the medium inserted in the channels and consequently offers considerable sensitivity of the resonance wavelength of the Bragg refraction index of the medium to be analysed.

A further result is considerable sensitivity to modifications of the optical parameters and especially to the refraction index as a function of the resonance wavelength over a wide range of refraction indices.

It is evident that since detection sensitivity of this type of fibre is not dependent on the total fibre diameter, the latter can be augmented to improve some characteristics of the fibre, especially mechanical, without as such diminishing the detection performances.

The presence of channels does not require dipping the network in the product to be analysed, thus offering numerous advantages in terms of flexibility of use.

In general, the fibres which have just been described enable detection and measuring of any physical-chemical parameter having an influence on the effective index of the mode of propagation, such as for example refraction index, absorption coefficient, density, concentration, luminescence, fluorescence, phosphorescence, fluorescence decrease time etc.

The arrangement of the sensor, which functions in reflection, also offers flexibility and simplicity of execution, also contributing to growing the reach of the feasible fields of application.

Of course, multiplexing of several measuring points is possible on the same fibre.

1. A fiber Bragg grating sensor (100) comprising a source (105) and a detection system (101) operating at a given wavelength of study, as well as a fibre (1) Bragg grating (6) linked to said source and to said system, said fibre being a microstructured optic fibre whereof the sheath (5) comprises channels (3) adjacent to the core (2) of the fibre (1), suitable for receiving a product to be analysed, characterised in that the number of channels (3) adjacent to the core (2) is between 2 and 5, and in that the diameter of the core (2) of the fibre (1) is adapted for an electromagnetic field of a wave guided by the fibre not to be confined in the core (2) of the fibre (1), the electromagnetic field extending in the channels (3).

2. Sensor according to claim 1, characterised in that the fibre (1) comprises exactly three channels (3) adjacent to the core (2).

3. Sensor (100) according to any one of the preceding claims, characterised in that the diameter of the core (2) is between 0.5 [symbol] and 20

[symbol]

4. Sensor according to any one of the preceding claims, characterised in that for a wavelength of study of the order of 1.55 [symbol] the diameter of the core (2) is between 3 [symbol] and 5

[symbol]

5. Sensor according to any one of the preceding claims, characterised in that at least one Bragg network is inscribed in the core (2) of the fibre (1).

6. Sensor (100) according to claim 5, characterised in that the Bragg network (6) is at a pitch of less than 10

[symbol]

7. Sensor (100) according to any one of the preceding claims, characterised in that the channels (3) are separated from one another by radial bridges (7) whereof the thickness is between 0.01 [symbol] and 10

[symbol]

8. Sensor according to any one of the preceding claims, characterised in that the fibre (1) is made of silica or plastic, the plastic being produced especially from PMMA, polystyrene, fluorous polymer or CYTOP.

9. Sensor according to any one of the preceding claims, characterised in that the core (2) of the fibre (1) is made of pure, or doped silica, or plastic material, the plastic being produced especially from PMMA, polystyrene, fluorous polymer or CYTOP.

10. Sensor (100) according to any one of the preceding claims, characterised in that it also comprises a system (300) for introduction and/or extraction of the product to be analysed in at least one of the channels (3).

11. A microstructured fibre Bragg grating (1) of a sensor according to any one of the preceding claims.

12. A process for determining the structure of a microstructured fibre according to claim 11, characterised in that the diameter of the core (2) of the fibre (1) is determined by fixing a given level of confinement and a given core diameter (2), in that the sensitivity of the fibre (1), comprising a core of given diameter, to the refraction index of a product to be analysed is determined by modelling, and in that the given diameter of the core (2) is made to evolve iteratively as a function of the determined sensitivity.

13. Use of the sensor (100) according to any one of claims 1 to 10 for measuring a physical-chemical parameter having an influence on the effective index of the mode of propagation, such as for example refraction index, absorption coefficient, density, concentration, luminescence, fluorescence, phosphorescence, fluorescence decrease time.
